(19) United States
(12) Patent Application Publication
(10) Pub. No.: US 2012/0275074 A1
(43) Pub. Date: Nov. 1, 2012

(54) ESD PROTECTION DEVICE

(75) Inventors: Peter Dill, Oberrieden (CH); Thomas E. Morf, Zurich (CH); Jonas R. Weiss, Zurich (CH)

(73) Assignee: International Business Machines Corporation, Armonk, NY (US)

(21) Appl. No.: 13/454,172

(22) Filed: Apr. 24, 2012

(30) Foreign Application Priority Data
Apr. 29, 2011 (EP) 11164303.7

(51) Int. Cl. H02H 9/04; H01F 27/29

(52) U.S. Cl. 361/56; 336/192

(57) ABSTRACT

An electrostatic discharge (ESD) protection device for protecting an I/O port of an electronic circuit from overvoltage and a coil structure for use in an ESD protection device. The ESD protection device includes: a plurality of inductors that are serially coupled in a line, where a node is formed between two neighboring inductors; and a plurality of protection arrangements adapted to conduct charges to one provided potential when an overvoltage is applied, where each of the protection arrangements is connected with one of the nodes, and where the serially coupled inductors are magnetically coupled with each other.

### CROSS-REFERENCE TO RELATED APPLICATION(S)

This application claims priority under 35 U.S.C. §119 to European Patent Application No. 11164303.7 filed Apr. 29, 2011, the entire contents of which are incorporated by reference herein.

### BACKGROUND OF THE INVENTION

1. Field of the Invention

The present invention relates to an electrostatic discharge protection device (ESD protection device) for I/O ports of electronic circuits and in particular to ESD protection devices for high bandwidth I/O ports. Furthermore, the present invention relates to a topology for implementing such a device on a surface of an electronic circuit board or an integrated circuit.

2. Description of the Related Art

ESD protection for electronic circuits, regardless whether integrated or not, is becoming increasingly difficult with the down-scaling of today's circuit manufacturing technologies. In the past, ESD protection was performed by merely providing ESD protection diodes to the I/O port which connected the I/O port with the high and the low supply voltage, respectively. Charges of high voltages applied to the I/O port are efficiently discharged through one of the ESD protection diodes to the respective supply potential. As the bandwidth of today's I/O ports is increasing, the capacitances of these ESD protection diodes become increasingly the limiting factor for the bandwidth of the I/O ports.

Known solutions for ESD protection further provide the use of T-coils to tune out the capacitance of the ESD protection diodes and to extend the frequency range. T-coils are inductors which are connected in series between the I/O-circuit and the I/O pad and which provide an additional port for the connection of the ESD protection diodes.

The ESD pulse suppression of ESD protection devices with T-coils is lower than that of ESD protection devices which are formed only with ESD protection diodes. This is due to the magnetic coupling in the T-coils which allows especially a very short CDM pulse to partially bypass the ESD protection diodes. This issue is usually overcome with an additional resistor and ESD protection diodes, specifically for CDM pulse protection. This additional protection requires larger ESD protection diodes and limits the bandwidth of the I/O port with their parasitic node capacitances.

Furthermore, the overvoltage allowed at the I/O ports of integrated devices and of common electronic circuit boards where the range of the supply voltage for operating the device is between 1 and 1.5 Volt, is usually not more than another 1.5 Volt. This requires an efficient ESD protection. Hence, there is a need to provide an ESD protection device that allows for a high bandwidth of passing through signals and that provides a high protection by efficiently discharging electrostatic charges. U.S. Pat. No. 5,969,929 discloses a distributed electrostatic discharge protection circuit for high frequency integrated circuits. A synthetic transmission line from an integrated circuit pad or package pin couples a plurality of ESD elements. The ESD elements, such as diodes, are distributed along the synthetic transmission line and coupled from it to the ground or a power supply. The effective impedance of the transmission line and the ESD elements is defined to match the impedance of an external line (e.g. 50 Ohms or 100 Ohms). Instead of the high-impedance transmission line segments, spiral inductors can be used to couple the ESD elements as they provide higher impedance than the transmission line segments.

Also in document Kleveland B. et al., “Distributed ESD protection for high-speed integrated circuits”, IEEE Electron Device Letters, Vol. 21, No. 8, August 2000, a distributed ESD protection device is disclosed, where ESD protection diodes are distributed along a transmission line having a controlled line impedance.

The above distributed ESD protection approaches help to increase the bandwidth for the passing signals. However, their area requirement is high.

### SUMMARY OF THE INVENTION

According to a first aspect of the present invention, an electrostatic discharge protection device for protecting an I/O port of an electronic circuit from overvoltage, is provided. The electrostatic discharge protection device includes: a plurality of inductors that are serially coupled in line, where a node is formed between two neighboring inductors, and the serially coupled inductors are magnetically coupled with each other; and a plurality of protection arrangements adapted to conduct charges to one provided potential when an overvoltage is applied, where each of the protection arrangements is connected with one of the nodes.

According to another aspect of the present invention, a coil structure for use in an electrostatic discharge (ESD) protection device is provided. The coil structure is formed in a plurality of conductive layers of an integrated device and by conductive segments on one or more of the conductive layers. The coil structure has a number of inner taps branching from the conductive segments thereby forming a plurality of serially connected and magnetically coupled inductors. One or more of the inductors having the highest inductance are formed at least partly by the conductive segments in one or more of the conductive layers providing the highest conductivity.

### BRIEF DESCRIPTION OF THE DRAWINGS

Preferred embodiments of the present invention are described in more detail in conjunction with the accompanying drawings in which:

FIG. 1 shows a schematic view of the ESD protection device according to an embodiment of the invention;

FIGS. 2a and 2b show a comparison of return loss and attenuation characteristics of an ESD protection device having only a diode arrangement, a single T-coil device and a multi T-coil device according to an embodiment of the invention;

FIGS. 3a and 3b show a comparison regarding the ESD voltage suppression of a single T-coil reference circuit, and a multi T-coil device according to an embodiment of the invention;

FIG. 4 shows a diagram illustrating the behavior of a multi T-coil arrangement compared to a single T-coil arrangement concerning the ESD protection according to an embodiment of the invention;

FIG. 5 shows a perspective view of a coil structure with four inner taps to connect the ESD protection elements according to an embodiment of the invention;

FIG. 6 shows a typical metallization structure of an SOI technology (SOI=silicon on insulator) according to an embodiment of the invention;

FIG. 7 shows the segments forming a first inductor with a first inductance in a coil structure for use in an ESD protection device according to an embodiment of the invention;

FIGS. 8 shows the segments forming a second inductor with a further inductance in the coil structure for use in an ESD protection device according to an embodiment of the invention;

FIGS. 9 shows the segments forming a third inductor with a further inductance in the coil structure for use in an ESD protection device according to an embodiment of the invention;

FIGS. 10 shows the segments forming a fourth inductor with a further inductance in the coil structure for use in an ESD protection device according to an embodiment of the invention; and

FIG. 11 shows the segments forming a fifth inductor with a further inductance in the coil structure for use in an ESD protection device according to an embodiment of the invention.

### DETAILED DESCRIPTION OF THE PREFERRED EMBODIMENTS

In an embodiment of the present invention, a series of inductors is used, where each node between two inductors is connected to a protection arrangement to discharge an overvoltage to at least one charge sink. To improve the characteristics of such an ESD protection device the inductors are magnetically coupled to each other, i.e. each inductor is magnetically coupled to all other inductors. The effectiveness of such an ESD protection device can be increased as several protective elements are provided in series. The overall ESD suppression can be improved since an incoming pulse is attenuated in four successive stages which act as a multiple cascaded low pass filter. In addition the coils may require less chip area compared to a classical distributed ESD protection approach since the coils are stacked on top of each other.

Furthermore, the serially coupled inductors can be formed by a single coil having inner taps for each of the nodes.

The inductances of the inductors can be higher at the ends of the line of serially coupled inductors than towards the center of the line of serially coupled inductors.

In particular, the inductances of the line of serially coupled inductors can be selected to be symmetrical to a center of the line of serially coupled inductors.

According to the embodiment of the present invention, each protection arrangement can have one or two protection diodes coupled with a high supply potential or a low supply potential, respectively, so that an overvoltage is discharged to the respective supply potential.

The protection diodes of each protection arrangement can have two protection diodes which are equal in size.

Similarly, the sizes of the protection diodes of each protection arrangement can be lower at the nodes at the ends of the line of serially coupled inductors than towards the center of the line of serially coupled inductors.

Moreover, the sizes of the protection diodes of each protection arrangement can be selected to be symmetrical to a center of the line of serially coupled inductors.

According to the embodiment of the present invention, the serially coupled inductors can be formed in a plurality of conductive layers of an integrated device, where the inductors are formed by conductive segments in one or more of the conductive layers, and where one or more of the inductors having the highest inductance are formed by conductive segments in one or more of the conductive layers providing the highest conductivity.

Segments of two conductive layers can be coupled in parallel to form a segment of increased conductivity. Hence, also conductive layers with a reduced conductivity can be used to form segments for windings of the inductors.

Moreover, the segments can be formed as straight lines of conductive material of the respective conductive layers where the inductors are formed as windings around a common inner area to provide the magnetic coupling. To use a common coil structure having windings with a number of turns, a magnetic coupling can be achieved in a simple manner. In particular, the shape of the area encompassed by the windings can be polygonal, such as rectangular.

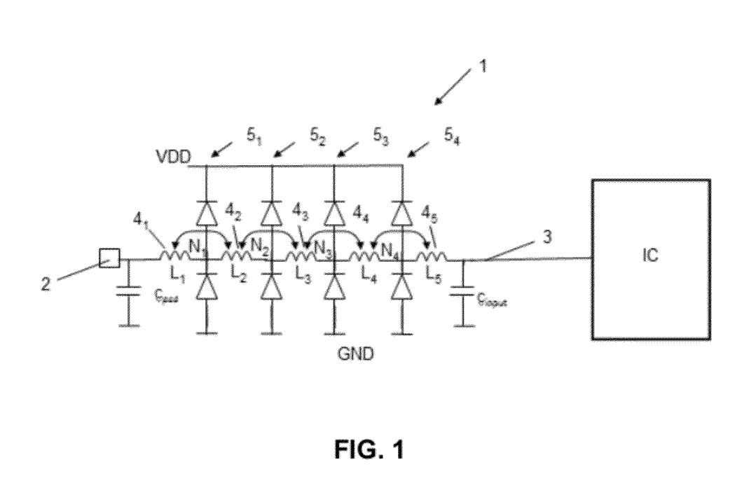

FIG. 1 shows a schematic view of an ESD protection device 1 having a first receiving pad 2, e. g. for receiving an external signal, and a second providing pad 3 serving as a protected output for providing the external signal to an internal IC circuitry, sensitive to overvoltage if accidentally applied to the receiving pad 2, e.g. by static discharges.

The receiving pad 2 and connected input provide a capacitance towards a ground potential GND which is indicated in the schematic view by the pad capacitances C_{pad} and Cᵢₙₚᵤₜ. The pad capacitance C_{pad} is formed by the size of the pad itself and the wiring that is connected to the respective pad 2.

Furthermore, the ESD protection device 1 includes a series connection of several (here five) inductors, such as coils 4₁, 4₂, 4₃, 4₄, 4₅, which directly connect the first pad 2 with the second pad 3. The inductors 4₁, 4₂, 4₃, 4₄, 4₅ are formed as coils having varying inductances L₁, L₂, L₃, L₄, L₅. The number of inductors and diode arrangement can vary from what is shown in the embodiment of the present invention as shown in FIG. 1. The minimum number of inductors to form the ESD protection device is 3.

At nodes N₁, N₂, N₃, N₄, which are formed between two neighboring coils 4₁, 4₂, 4₃, 4₄, 4₅, a diode arrangement 5₁, 5₂, 5₃, 5₄ is connected. Each diode arrangement 5₁, 5₂, 5₃, 5₄ in the present embodiment of the invention includes two diodes D₁, D₂, respectively. A first diode D₁ of each diode arrangement 5₁, 5₂, 5₃, 5₄ is connected by its anode terminal with a low supply voltage potential GND and by its cathode terminal with the respective node N₁, . . . , N₄. A second diode D₂ of each diode arrangement 5₁, 5₂, 5₃, 5₄ is connected by its anode terminal with the respective node N₁, . . . , N₄ and by its cathode terminal with a high supply voltage potential VDD.

The inductors 4₁, 4₂, 4₃, 4₄, 4₅ are magnetically coupled with each other so that each inductor 4₁, 4₂, 4₃, 4₄, 4₅ is magnetically coupled with any other inductor. This can be achieved by using a single coil having a plurality of taps forming the nodes N₁, N₂, N₃, N₄ as exemplarily described below.

The active sizes of diodes D₁, D₂ of each diode arrangement 5₁, 5₂, 5₃, 5₄ can be equal. However, the inner diode arrangements 5₂, 5₃ can have larger sized diodes, i.e. diodes of the inner diode arrangements 5₂, 5₃ having a higher active width than the outer diode arrangements 5₁, 5₄. The outer diode arrangements 5₁, 5₄ can have smaller sized diodes, i.e. diodes of the outer diode arrangements 5₁, 5₄ having a lower active width than the outer diode arrangements 5₁, 5₄.

The coils/inductors 4₁, 4₂, 4₃, 4₄, 4₅ can have a similar arrangement while the outer coils are given a higher inductance L₁, L₂, L₃, L₄, L₅ than the inner coils.

According to another embodiment of the present invention, the size of the diodes D₁, D₂ and the inductors of the coils 4₁, 4₂, 4₃, 4₄, 4₅ are arranged symmetrically, respectively. The inductance L₁, L₂, L₃, L₄, L₅ of the coils 4₁, 4₂, 4₃, 4₄, 4₅ can be arranged symmetrically to the center coil having the inductance L₃ in the present embodiment.

In case where an even number of coils 4₁, 4₂, . . . is used, an odd number of diode arrangements 5₁, 5₂, . . . is connected to the nodes N between each two neighboring coils 4, such that the center diode arrangement would form the symmetry line. The symmetry is a design rule which can be applied for the sizing of the diode arrangements 5₁, 5₂, . . . and/or the sizing of the inductance L₁, L₂, . . . .

When symmetry for the inductance L₁, L₂, . . . of the coils 4₁, 4₂, . . . is chosen, the inductance L₁, L₂, . . . is selected to be high for the outer coils and have decreasing values towards the center inductor or towards the center diode arrangement. Similarly, the diodes D₁, D₂ of the diode arrangements 5₁, 5₂, . . . have a low width, i.e. are small sized, while the width of the diodes D₁, D₂ of the diode arrangement 5₁, 5₂, . . . is selected to increase towards the center inductor or the center diode arrangement, respectively.

In an example configuration as shown in FIG. 1, the inductances of L₁, L₂, L₃, L₄, L₅ are as follows: L₁=242 pH, L₂=127 pH, L₃=64 pH, L₄=127 pH, L₅=242 pH. In this example, the width of the diodes D₁, D₂ of the diode arrangements 5₁, 5₂, 5₃, 5₄ can be selected as W_{D1,D2} (5₁, 5₄)=40 μm, W_{D1,D2} (5₂, 5₃)=120 μm.

Generally, deviations from the selected dimensions are allowed for one or more of the inductors L₁, L₂, L₃, L₄, L₅ and diodes D₁, D₂.

The inductors L₁, L₂, L₃, L₄, L₅ are formed as coils 4₁, 4₂, 4₃, 4₄, 4₅ which are magnetically coupled to each other. The magnetic coupling can be achieved by forming a single coil having a number of taps corresponding to the number of nodes N₁, N₂, N₃, N₄ between the single coils 4₁, 4₂, 4₃, 4₄, 4₅ of the ESD protection device.

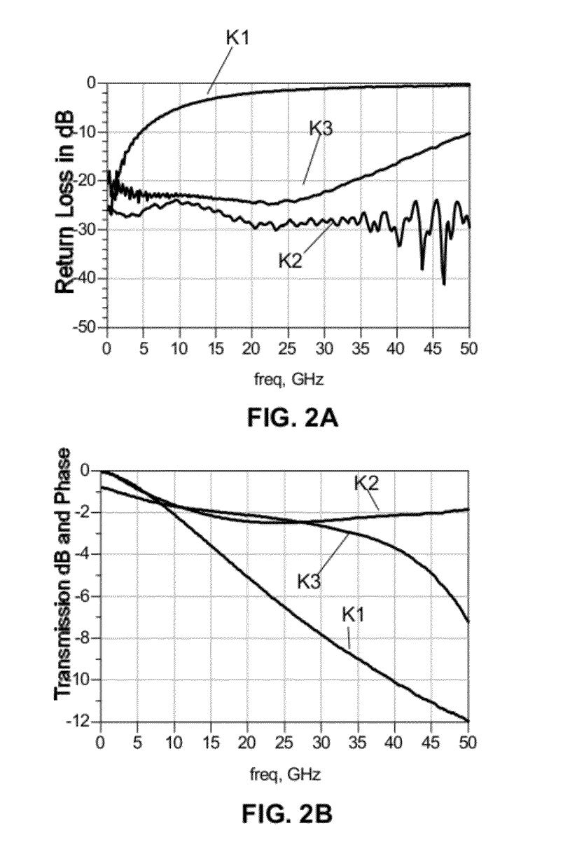

FIG. 2 shows a qualitative comparison between ESD protection devices having only one diode arrangement (K1), a single T-coil arrangement (K2) and a multi T-coil arrangement (K3). The diagram according to FIG. 2a shows the return loss over the frequency of an applied signal. The diagram according to FIG. 2b shows the transmission attenuation over frequency of an applied signal. It can be seen in the diagram of FIG. 2a that the single T-coil arrangement and the multi T-coil arrangement provide a very high bandwidth. Also for the transmission attenuation the characteristics of a single T-coil arrangement and a multi T-coil arrangement are similarly below 30 GHz. The multi T-coil has less frequency dependent loss which is beneficial. One advantage of a multi T-coil is its superior ESD pulse suppression.

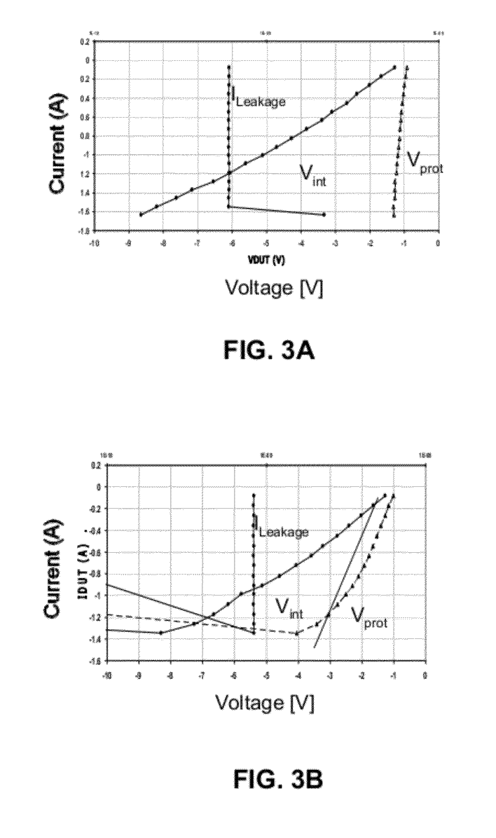

FIGS. 3a and 3b show diagrams illustrating the behavior of a multi T-coil arrangement (FIG. 3a) compared to a single T-coil arrangement (FIG. 3b) concerning the ESD protection. It is applied a maximum current pulse of 1,3 A with 100 ns pulse length, which corresponds to a 2 kV pulse according to the commonly applied Human Body Model (HBM). As can be seen in FIG. 3a, the output voltage Vₚᵣₒₜ, i.e. the voltage at the providing pad (protected output) 3, is kept low even at currents of 1,6 A while the output voltage Vₚᵣₒₜ at the providing pad 3 in case of a single T-coil arrangement (FIG. 3b) is about a factor 2 higher. This can be explained by the successive diodes which are in the path between the pad and the protective output distributed along the coil.

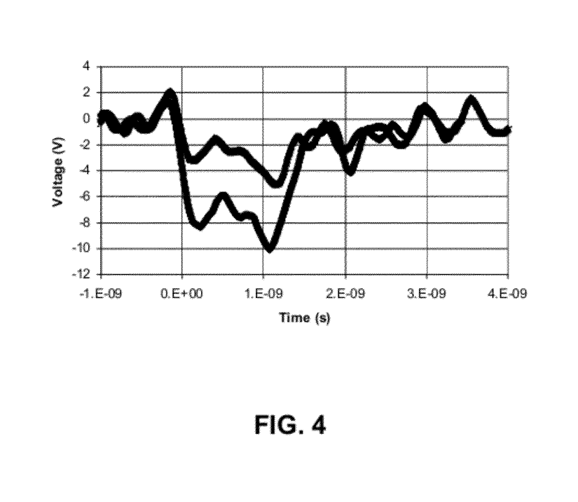

FIG. 4 shows another diagram illustrating a comparison of the ESD protection capability between a multi T-coil arrangement (T1) and a single T-coil arrangement (T2). The resulting output voltage Vₒᵤₜ at a current pulse with a peak current of Iₚₑₐₖ of 4,5 A of a 1,25 ns pulse is charted. The output voltage of the multi T-coil arrangement reaches 5V while the output voltage of the single T-coil arrangement exceeds 10V. Hence, the multi T-coil arrangement provides an ESD protection factor of more than 2 compared to a single T-coil arrangement.

Consequently, a multi tap T-coil arrangement as described above can provide an improved ESD protection while having similar frequency characteristics for most applications compared to the single T-coil arrangement.

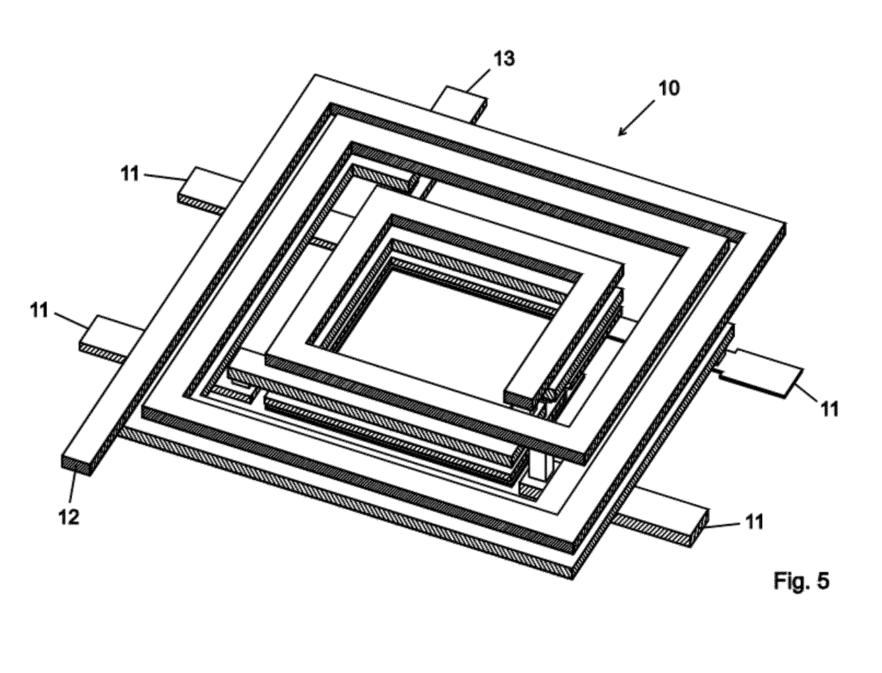

The following FIGS. 5 to 11 illustrate the integration of a coil structure as a coil having taps representing the nodes of the ESD protection device.

According to another embodiment of the present invention, a coil structure can be integrally formed in a plurality of conductive layers, where the structure has more than one inner tap to connect an ESD protection element.

Furthermore, conductive segments of two conductive layers are coupled in parallel to form a common segment of increased conductivity.

The conductive segments can be formed as straight lines of conductive material of the respective conductive layers where the inductors are formed as polygonal windings around a common inner area.

FIG. 5 shows a perspective view of a coil structure 10 to be used in the ESD protection device 1 as described above. The coil structure 10 has substantially a rectangular cross-section and represents a coil having four inner taps 11, each for connecting one diode arrangement as described above and one input terminal 12 and one output terminal 13. The coil structure 10 is integrated by using an SOI technology within a number of metal layers. However, any other integration technology can be applied as well. The cross-section can differ from a rectangular shape and generally formed to encompass an inner space. In particular the cross-section can be polygonal in shape.

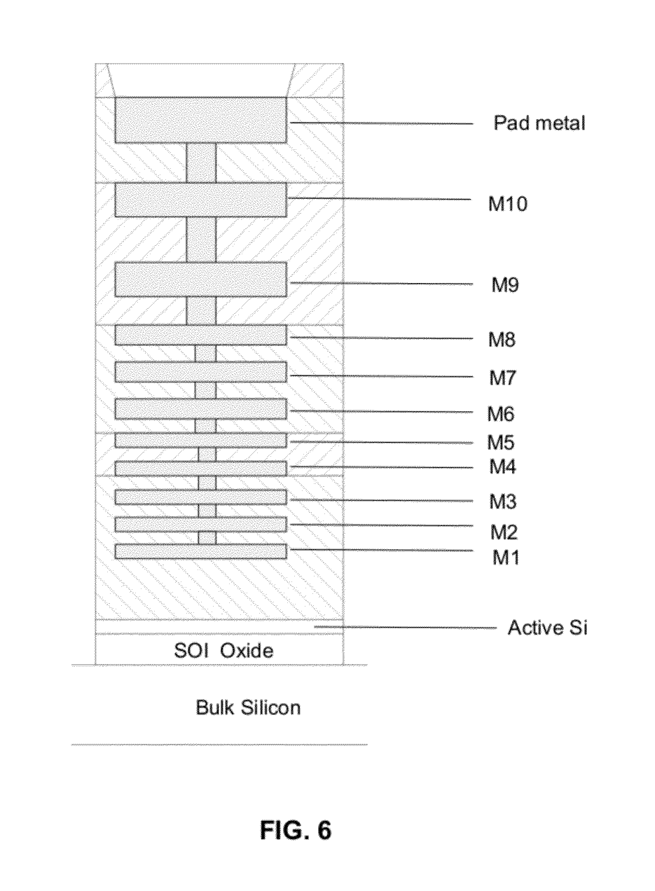

FIG. 6 schematically shows the metal layers of a typical SOI CMOS process which can be used to form the coil. It can be seen that 10 metal layers M1 to M10 can be used having different thickness and therefore different electrical conductivities.

The coil of FIG. 5 can be formed according to the symmetry design rule as described above and therefore has the lowest resistance and the highest current carrying capability for the portions forming the outer inductors L₁ and L₅ which also have a high inductance. For the inner inductors L₂, L₃, L₄, which are smaller than the outer inductors L₁, L₅, a lower conductivity can be accepted. A given example therefore uses the upper metal layer that provides the greatest thickness (highest conductivity) for the highest inductance of the multi coil while the smaller inductors are formed by the metal layer having a reduced thickness.

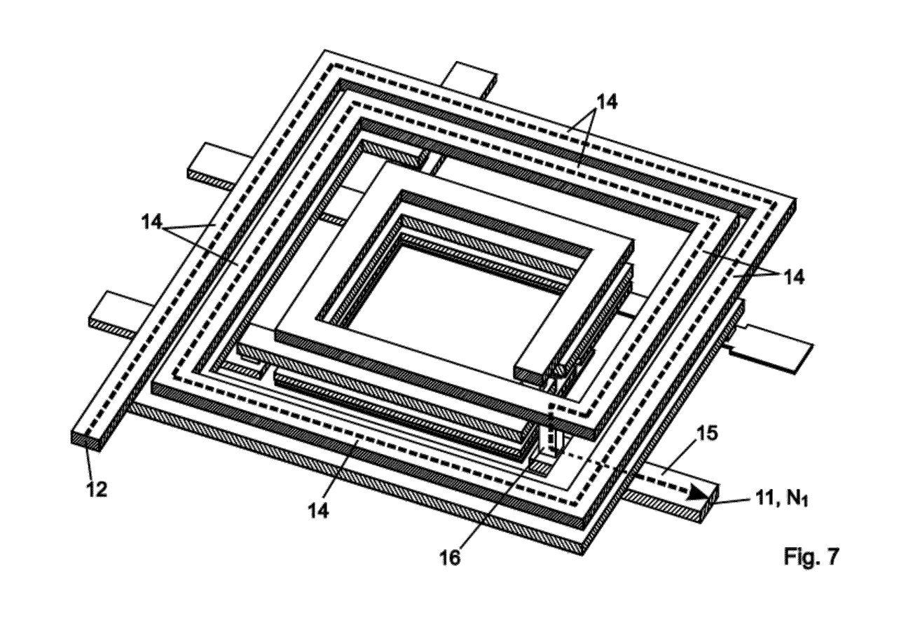

FIG. 7 shows the portion of the coil of FIG. 5 which acts as the first inductor L₁ between the first pad 2 connected at input terminal 12 of the coil and the first node N₁. It is formed by 7 segments 14 of the rectangular coil structure 10. It can be seen that only the top metal layer M10 is used, which provides a significant thickness. For providing the inner tap 11 at the first node N₁, lower metal layers M6-M8 are used for an underpass 15 which are connected by a through-via connection 16.

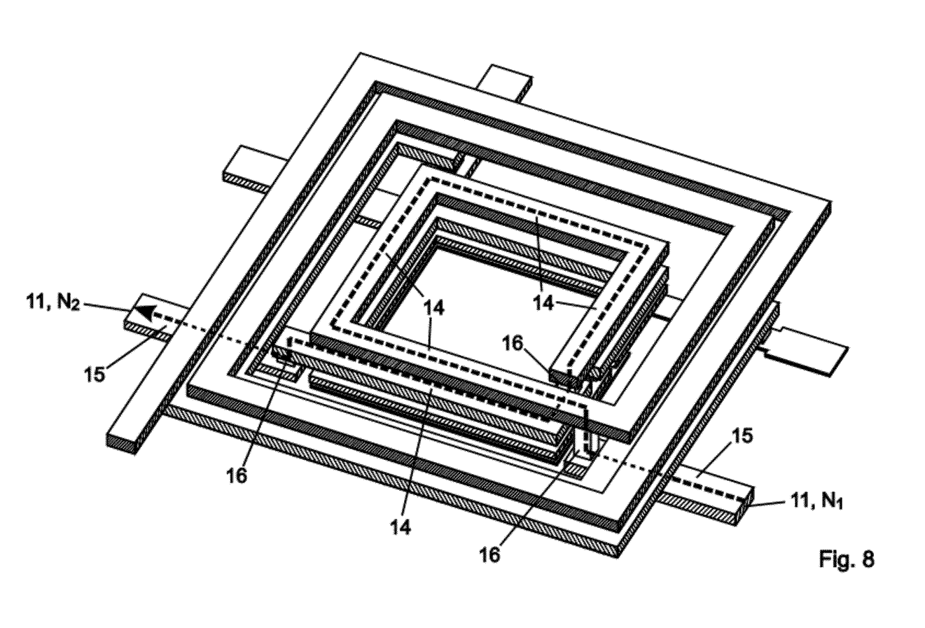

As shown in FIG. 8, four segments 14 of the top metal layer M10 are used to form one winding which is then connected to the next lower metal layer M9 with a through-via 16 to connect another segment of a winding which is then connected to a tap 11 of the second node N₂ by a trough via connection 16 and underpass 15.

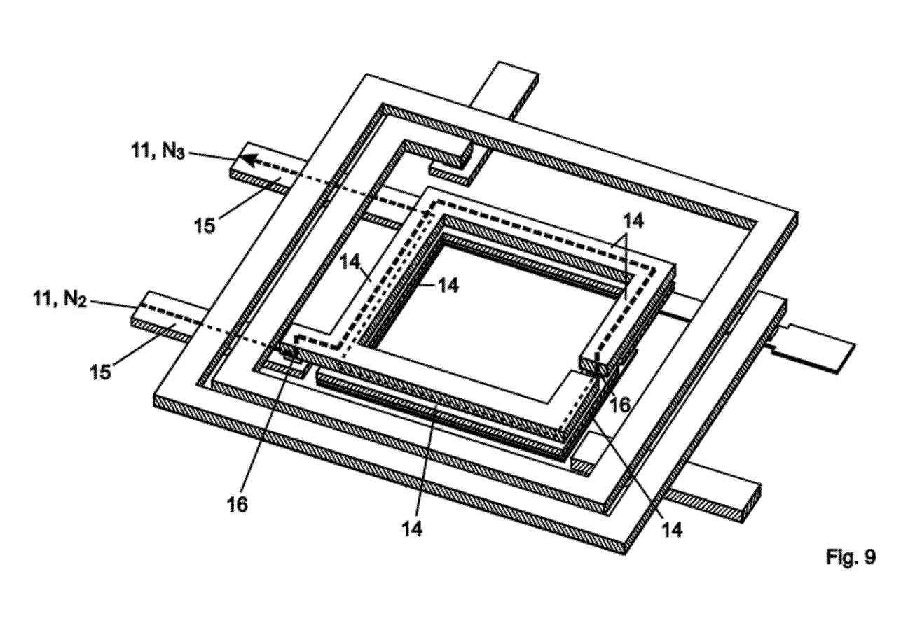

At the inner tap 11 of the second node N₂, three segments 14 in the metal layer M9 are connected as shown in FIG. 9 and then by means of the through-via connection 16 further three segments 14 in the combined metal layer M7, M8 to the inner tap 11 of the third node N₃.

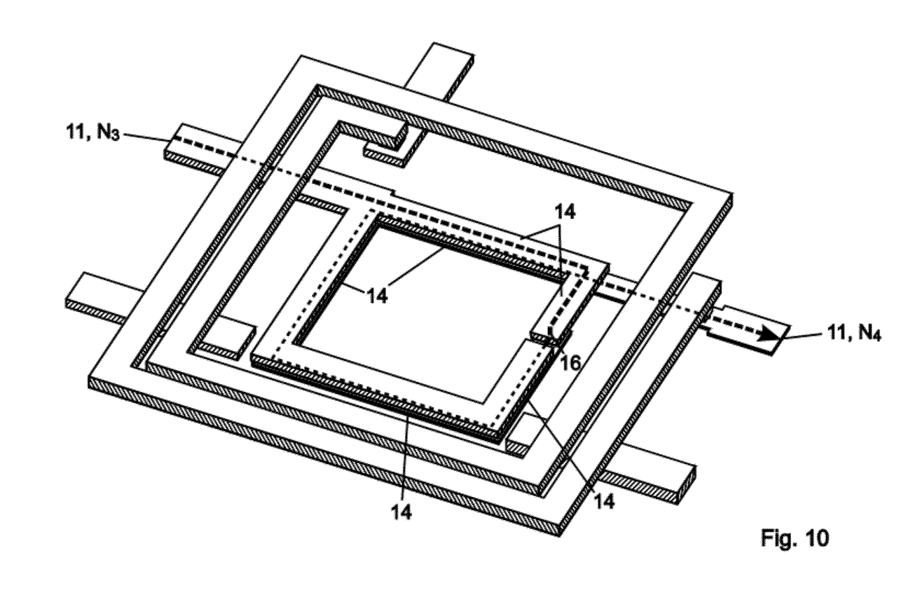

Furthermore, as shown in FIG. 10, the tap of the third node N3 is coupled with two serially connected segments 14 of the metal layer M7, M8 and then to four serially connected segments 14 on a sixth metal layer M6 by means of a through via connection 16.

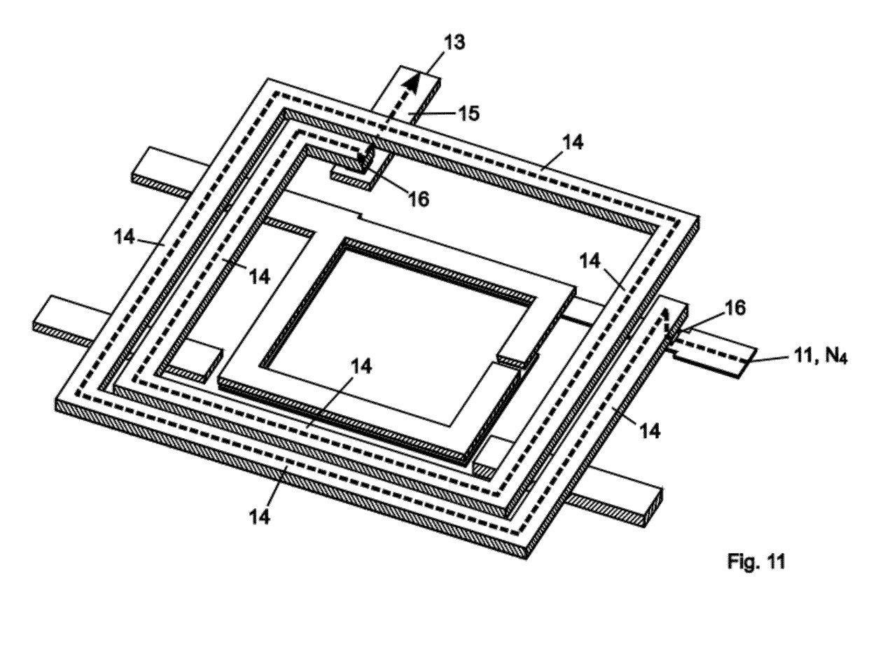

FIG. 11 shows the fifth inductor L₅, which requires a low resistance. The tap 11 of the fourth node N₄ is connected by a through-via connection 16 to the metal layer M9, where seven segments 14 are coupled to form the respective inductivity.

In the present example, as the metal layers M7 and M8 have a low thickness they are combined by connecting them in parallel to reduce the resistance and to increase the current carrying capability.

In general, for implementing the distributed coil in an integrated circuit the multi-tap coil is formed by segments 14 in a number of metal layers M1-M10 interconnected by through-via connections 16, where the level of metal layer is selected according to the respective inductance and conductivity used for each inductor portion of the distributed coil. Furthermore, the coil structure can be formed using segments of different length. However, to ensure a sufficient magnetic coupling between the portions of the coil, the segments shall form windings encompassing a common inner coil space.

1-11. (canceled)

12. A coil structure for use in an electrostatic discharge (ESD) protection device, the coil structure comprising:
a plurality of conductive layers of an integrated device,
conductive segments in one or more of the conductive layers, and
a number of center taps branching from the conductive segments thereby forming a plurality of serially connected and magnetically coupled inductors, wherein one or more of the inductors having the highest inductance are formed at least partly by the conductive segments in one or more of the conductive layers providing the highest conductivity.

13. The coil structure according to claim 12, wherein conductive segments of two of the conductive layers are coupled in parallel to form a common segment of increased conductivity.

14. The coil structure according to claim 12, wherein:
the conductive segments are formed as straight lines of conductive material of the respective conductive layers; and
the inductors are formed as rectangular windings around a common inner area to provide the magnetic coupling.
